(19) United States
(12) Patent Application Publication
(10) Pub. No.: US 2026/0347612 A1
(43) Pub. Date: Nov. 5, 2026

(54) SULFURIZED STABILIZERS FOR USE IN EPOXY FUNCTIONAL AND PHOSPHOLIPID CONTAINING COMPOSITIONS FOR ASPHALT APPLICATIONS

(71) Applicant: CARGILL, INCORPORATED, Wayzata, MN (US)

(72) Inventors: Sung Ahn, St. Paul, MN (US); Cristian Calcanas, Minneapolis, MN (US); Todd L. Kurth, Maple Grove, MN (US); Hassan Ali Tabatabaee, Plymouth, MN (US)

(73) Assignee: CARGILL, INCORPORATED, Wayzata, MN (US)

(21) Appl. No.: 19/123,842

(22) PCT Filed: Nov. 3, 2023
(86) PCT No.: PCT/US2023/078644

§ 371 Date: Apr. 24, 2025

Related U.S. Application Data
(60) Provisional application No. 63/382,331, filed on Nov. 4, 2022.

(51) Int. Cl. C08L 95/00; C08K 5/521; C08L 91/04; E01C 7/26

(52) U.S. Cl. CPC C08L 95/00; C08K 5/521; C08L 91/04; E01C 7/267; C08L 2205/025; C08L 2205/03; C08L 2310/00; C08L 2555/64

(57) ABSTRACT

The present technology provides an asphalt additive that includes a phospholipid material, an epoxidized renewable oil or fat, and a sulfurized renewable oil stabilizer, where the epoxidized renewable oil or fat has an oxirane content of about 1.0% to about 15.0% and where the sulfurized renewable oil stabilizer having a polymeric distribution having about 2 weight percent (wt %) to about 80 wt % oligomer content, optionally, a polydispersity index (PDI) ranging from about 1.0 to about 5.0; and a sulfur content ranging from about 0.001 wt % to about 8 wt %. The present technology also provides use of the asphalt additive in asphalt applications and methods of making thereof.

### CROSS-REFERENCE TO RELATED APPLICATIONS

This application claims the benefit of U.S. Provisional Patent Application No. 63/382,331, filed Nov. 4, 2022, which is incorporated herein by reference in its entirety.

### TECHNICAL FIELD

The present technology relates to asphalt additives for use in asphalt applications. In particular, the present technology relates to asphalt additives that include epoxidized renewable oils or fats, phospholipid materials, and sulfurized renewable oil stabilizers for use as a Warm Mix Asphalt additive or to improve antistrip properties, and methods of making and using thereof, in asphalt applications.

### SUMMARY

In one aspect, the present technology provides an asphalt additive that includes a phospholipid material, an epoxidized renewable oil or fat, where the epoxidized renewable oil or fat has an oxirane content of about 1.0% to about 15.0%, and a sulfurized renewable oil stabilizer having a polymeric distribution having 2 wt % to about 80 wt % oligomer content; and a sulfur content ranging from about 0.001 wt % to about 8 wt % based on total weight of the sulfurized renewable oil stabilizer; wherein the sulfurized renewable oil stabilizer is a polymerized oil obtained via sulfurization. The sulfurized renewable oil stabilizer may further have a PDI of about 1.0 to about 5.0. For example, the asphalt additive may include a phospholipid material, an epoxidized renewable oil or fat, where the epoxidized renewable oil or fat has an oxirane content of about 1.0% to about 15.0%, and a sulfurized renewable oil stabilizer having a polymeric distribution having 2 wt % to about 80 wt % oligomer content; a PDI ranging from about 1.0 to about 5.0; and a sulfur content ranging from about 0.001 wt % to about 8 wt % based on total weight of the sulfurized renewable oil stabilizer: wherein the sulfurized renewable oil stabilizer is a polymerized oil obtained via sulfurization.

In an aspect, the present technology provides use of the asphalt additive as described herein to reduce or prevent stripping in asphalt applications.

In another aspect, the present technology provides use of the asphalt additive as described herein as a compaction aid in asphalt applications.

In another aspect, the present technology provides use of the asphalt additive as described herein as an adhesion promoter in asphalt applications.

In yet another related aspect, the present technology provides use of the asphalt additive as described herein as a warm mix asphalt additive or a hot mix asphalt additive in asphalt applications. For example, the use of the asphalt additive is as a warm mix asphalt additive. In another example, the use of the asphalt additive is as a hot mix asphalt additive.

In another aspect, the present technology provides an asphalt binder that includes bitumen; and an asphalt additive as described herein in any aspect.

In yet another aspect, the present technology provides an asphalt concrete that includes about 0.25 wt % to about 8.0 wt % of an asphalt binder as described herein in any aspect (based on total weight of the asphalt concrete) and about 92.00 wt % to about 99.75 wt % of mineral aggregate (based on total weight of the asphalt concrete). As described herein, the asphalt binder includes bitumen and the asphalt additive.

In another aspect, the present technology provides a process for preparing a stable asphalt additive blend. The method of preparing the stable asphalt additive blend includes: mixing a phospholipid material, an epoxidized renewable oil or fat having an oxirane content of about 1.0% to about 15.0%, and a sulfurized renewable oil stabilizer to obtain the asphalt additive blend; wherein the sulfurized renewable oil stabilizer has a polymeric distribution having about 2 wt % to about 80 wt % oligomer content; and a sulfur content ranging from about 0.001 wt % to about 8 wt % based on total weight of the sulfurized renewable oil stabilizer. The sulfurized renewable oil stabilizer may further have a PDI of about 1.0 to about 5.0. For example, the sulfurized renewable oil stabilizer has a polymeric distribution having about 2 wt % to about 80 wt % oligomer content; a PDI ranging from about 1.0 to about 5.0; and a sulfur content ranging from about 0.001 wt % to about 8 wt % based on total weight of the sulfurized renewable oil stabilizer.

In another aspect, the present technology provides a method for reducing or preventing stripping, promoting adhesion, aiding compaction, and/or improving durability of an asphalt concrete that includes:
adding an asphalt additive as described herein to bitumen to obtain an asphalt binder, and
combining the asphalt binder to mineral aggregates to obtain an asphalt concrete:
wherein the asphalt concrete includes about 0.25 wt % to about 8.0 wt % of the asphalt binder and about 92.00 wt % to about 99.75 wt % of the mineral aggregates.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter. One aspect described in conjunction with a particular aspect is not necessarily limited to that aspect and can be practiced with any other aspect(s).

Throughout this document, particularly in terms of providing a written description, all values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. Any listed range can be easily recognized as sufficiently describing and enabling the same range being broken down into at least equal halves, thirds, quarters, fifths, tenths, etc. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

As used herein, the singular forms “a,” “an,” and “the” and similar referents in the context of describing the elements (especially in the context of the following claims) include plural referents unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. In the event of inconsistent usages between this document and those documents so incorporated by reference, the usage in the incorporated reference should be considered supplementary to that of this document; for irreconcilable inconsistencies, the usage in this document controls.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure and are not meant to be limiting in any fashion.

In the methods described herein, the acts can be carried out in a specific order as recited herein. Alternatively, in any aspect(s) disclosed herein, specific acts may be carried out any order without departing from the principles of the disclosure, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

As used herein, “about” will be understood by persons of ordinary skill in the art and will vary to some extent depending upon the context in which it is used. If there are uses of the term which are not clear to persons of ordinary skill in the art, given the context in which it is used. “about” will mean up to plus or minus 10% of the particular term.

The term “substantially” as used herein refers to a majority of, or mostly, as in at least about 85%.

As used herein, the following terms have the following meanings unless expressly stated to the contrary.

The term “renewable oil or fat” as used herein refers to an oil or fat obtained from plant, animal, or microbial sources. The term “renewable oil or fat” includes renewable oil and fat derivatives unless otherwise indicated. Typically, renewable oils or fats are triacylglycerides. Examples of renewable oils include, but are not limited to, vegetable oils, algae oils, animal fats, tall oils, derivatives of these oils, combinations of any of these oils, and the like. Representative non-limiting examples of vegetable oils include canola oil, rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard oil, camelina oil, pennycress oil, hemp oil, algal oil, jojoba oil, and castor oil. Representative non-limiting examples of animal sources include animal fats such as lard, tallow, poultry fat, yellow grease, and fish oil. Tall oils are by-products of wood pulp manufacture. As used herein, “vegetable oils” refers to oils derived from vegetables and/or oil seeds. Typically, the renewable oil or fat may be refined, bleached, and/or deodorized. The renewable oil or fat may be present individually or as mixtures thereof. The renewable oil or fat may be modified; for example, the renewable oil or fat may be an epoxidized, hydrogenated, and/or fractionated renewable oil or fat. Renewable oil or fat may be a polymerized renewable oil or fat (“polymerized oil”) as described herein in any aspect.

The term “epoxidized” or “oxirane” refers to the presence of an epoxide (or epoxy) ring as shown below:

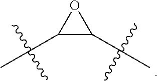 [SMILES: *C1OC1*]

The term “epoxidized renewable oil or fat” refers to a renewable oil or fat as described herein having the presence of an epoxide ring functionality along the fatty acid hydrocarbon chain. Typically, the epoxidized renewable oils or fats as described herein can be obtained by modifying renewable oils or fats with a high content of unsaturated fatty acids or fatty acid derivatives (i.e., polyunsaturated fatty acids (PUFA), monounsaturated fatty acids (MUFA), and the like). Exemplary renewable oils or fats with high PUFA and/or MUFA content may include, but are not limited to, soybean oil and linseed oil. For example, renewable oils and fats may be epoxidized by treatment with peracid. To increase the epoxide content such that the renewable oil or fat has a high concentration of di- and tri-epoxy fatty acid chains, the renewable oil or fat may be epoxidized and fractionated.

The term “oxirane content” or “epoxy oxirane content” (EOC) refers to the ratio of the sum of the total oxirane functionality molecular weight in a molecule to the total molecular weight and is represented as the percent (%) EOC. The American Oil Chemist's Society (AOCS) maintains analytical methods for a wide variety of tests performed on vegetable oils. As used herein, EOC is determined via AOCS Standard Procedure Cd 9-57.

An “acylglyceride” refers to a molecule having at least one glycerol moiety with at least one fatty acid residue that is linked via an ester bond. For example, acylglycerides can include monoacylglycerides, diacylglycerides, and triacylglycerides. The group acylglycerides can be further refined by additional descriptive terms and can be modified to expressly exclude or include certain subsets of acylglycerides.

A “monoacylglyceride” refers to a molecule having a glycerol moiety with a single fatty acid residue that is linked via an ester bond. The terms “monoacylglycerol,” “monoacylglyceride,” “monoglyceride,” and “MAG” are used interchangeably herein. Monoacylglycerides include 2-acylglycerides and 1-acylglycerides.

A “diacylglyceride” refers to a molecule having a glycerol moiety having two fatty acid residues linked via ester bonds. The terms “diacylglycerol,” “diacylglyceride,” “diglyceride,” and “DAG” are used interchangeably herein. Diacylglycerides include 1,2-diacylglycerides and 1,3-diacylglycerides.

A “triacylglyceride” refers to a molecule having a glycerol moiety that is linked to three fatty acid residues via ester bonds. The terms “triacylglycerol,” “triacylglyceride,” “triglyceride.” and “TAG” are used interchangeably herein.

The term “fatty acid” as used herein can refer to a molecule comprising a hydrocarbon chain and a terminal carboxylic acid group. As used herein, the carboxylic acid group of the fatty acid may be modified or esterified, for example as occurs when the fatty acid is incorporated into a glyceride or another molecule (e.g., COOR, where R refers to, for example, a carbon atom). Alternatively, the carboxylic acid group may be in the free fatty acid or salt form (i.e., COO″ or COOH). The ‘tail’ or hydrocarbon chain of a fatty acid may also be referred to as a fatty acid chain, fatty acid sidechain, or fatty chain. The hydrocarbon chain of a fatty acid will typically be a saturated or unsaturated aliphatic group. A fatty acid having N number of carbons, will typically have a fatty acid side chain having N−1 carbons. However, the subject application also relates to modified forms of fatty acids, e.g., epoxidized fatty acids, and thus the term fatty acid may be used in a context in which the fatty acid has been substituted or otherwise modified as described.

A “fatty acid residue” is a fatty acid in its acyl or esterified form.

A “saturated” fatty acid is a fatty acid that does not contain any carbon-carbon double bonds in the hydrocarbon chain. An “unsaturated” fatty acid contains one or more carbon-carbon double bonds. A “polyunsaturated” fatty acid contains more than one such carbon-carbon double bond while a “monounsaturated” fatty acid contains only one carbon-carbon double bond. Carbon-carbon double bonds may be in one of two stereoconfigurations denoted cis and trans. Naturally occurring unsaturated fatty acids are generally in the “cis” form. Epoxidized renewable oil or fat may include one or more epoxide rings formed from cis or trans carbon-carbon double bonds.

Non-limiting examples of fatty acids include C8, C10, C12, C14, C16 (e.g., C16:0, C16:1), C18 (e.g., C18:0, C18:1, C18:2, C18:3, C18:4), C20 and C22 fatty acids. For example, the fatty acids can be caprylic (8:0), capric (10:0), lauric (12:0), myristic (14:0), palmitic (16:0), stearic (18:0), oleic (18:1), linoleic (18:2) and linolenic (18:3) acids.

The fatty acid composition of an oil can be determined by methods well known in the art. Hydrolysis of the oil's components to produce free fatty acids, conversion of the free fatty acids to methyl esters, and analysis by gas-liquid chromatography (GLC) is the universally accepted standard method to determine the fatty acid composition of an oil sample. AOCS (2009) Ce 1-62 describes the procedure used.

The terms “sulfurized renewable oil stabilizer”, “sulfurized renewable oil”, or “sulfurized oil” refer to a renewable oil that has undergone polymerization through a sulfurization process. The sulfurized renewable oil may generally be referred to as a “polymerized renewable oil” or “polymerized oil” having a specified sulfur content. In the various aspects, polymerization via sulfurization of the renewable oil or fat may be achieved through crosslinking of the fatty acid chains and/or the glyceride fraction of the triglyceride molecules contained in the renewable oil or fat utilizing a sulfur-containing compound, such as a sulfur-containing compound that may be in a reduced form. Typically, the polymerized oil is the polymerization product of a reaction mixture that includes a starting renewable oil or fat and the sulfur-containing compound. The starting renewable oil or fat may be any suitable renewable oil or fat as described herein. Additionally. or alternatively, the starting renewable oil or fat may include triacylglycerols or other oil components from non-natural sources, such as acylglycerols (i.e., TAGs, DAGs, or MAGs) having non-naturally occurring chain lengths.

In any aspect, the polymerized renewable oil or fat may be obtained by a method that includes (a) heating a starting renewable oil or fat, (b) adding a sulfur-containing compound to the heated oil or fat, and (c) allowing the sulfur-containing compound to react with the oil to produce the polymerized oil having a polymeric distribution of about 2 wt % to about 80 wt % oligomer content, and sulfur content from about 0.001 wt % to about 8 wt %. For example, the polymerized oil obtained according the method described in this paragraph may further have a PDI of about 1.0 to about 5.0.

In a first step, the renewable oil or fat is heated in a vessel equipped with an agitator to at least 100 °C, preferably heated to at least 115 °C. The sulfur-containing compound is gradually added to the heated renewable oil or fat and may be added in either solid or a molten form, however it shall be understood that the sulfur-containing compound may be added before the renewable oil or fat or simultaneously with the renewable oil or fat. The sulfur-containing compound may be elemental sulfur, but is not limited to such. The reaction between the sulfur and renewable oil or fat may increase the temperature of the renewable oil or fat-sulfur mixture. Preferably, the reaction mixture is held at temperatures between about 130 °C and 250 °C, more preferably between about 130 °C and about 220 °C, and even more preferably between about 160 °C and about 200 °C during the course of the reaction.

The oil-sulfur mixture may be continuously sparged with a gas-containing stream during the polymerization reaction between the renewable oil or fat and the sulfur. The gas-containing stream may be selected from the group consisting of nitrogen, air, and other gases. The gas-containing stream may help facilitate the reaction and may also assist in reducing odors (H₂S and other sulfides) associated with the reaction, in the final product. Use of air can be beneficial, as it may lead to oxi-polymerization of the renewable oil or fat in addition to the sulfurization process. Optionally, accelerators may be used to increase the rate of the reaction: for example, suitable accelerators may include, but are not limited to, zinc oxide, magnesium oxide, dithiocarbamates. Suitable sulfurized renewable oils and methods for preparing the same for use in the present invention are described in PCT Application Serial No. PCT/US2016/019767 entitled “POLYMERIZED OILS & METHODS OF MANUFACTURING THE SAME,” filed on Feb. 26, 2016, the entire contents of which are hereby incorporated by reference for the background information and methods set forth therein. Preferably, the sulfurized renewable oil may be a blend of a sulfurized renewable oil and non-sulfurized renewable oil. Preferably, the sulfurized renewable oil is not diluted with a non-sulfurized renewable oil: for example, greater than 85 wt %, preferably 90 wt %, more preferably 95 wt %, even more preferably 99.5 wt %, most preferably 99 wt % to 100 wt % based on total weight of the sulfurized renewable oil.

The term “flash point” or “flash point temperature” refers to a measure of the minimum temperature at which a material will initially flash with a brief flame. It is measured according to the method of ASTM D-92 using a Cleveland Open Cup and is reported in degrees Celsius (°C).

The term “oligomer” refers to a polymer having a number average molecular weight (Mn) larger than 1000. A monomer makes up everything else and includes morioacylgyclerides NAG), diacylglycerides (DAG), triacylglyerides (TAG), and free fatty acids (FFA).

The term “polydispersity index” (PDI) (also known as “Molecular Weight Distribution”) refers to the ratio of weight average molecular weight (Mw) to number average molecular weight (Mn). The polydispersity data is collected using a Gel Permeation Chromatography instrument equipped with a Waters 510 pump and a 410 differential refractometer. Samples are prepared at an approximate 2% concentration in a THF solvent. A flow rate of 1 ml/minute and a temperature of 35 °C are used. The columns consist of a Phenogel 5 micron linear/mixed Guard column, and 300×7.8 mm Phenogel 5 micron columns (styrene-divinylbenzerie copolymer) at 50, 100, 1000, and 10000 Angstroms. Molecular weights were determined using the following standards:

| | | | | | Epoxidized | | | |
|---|---|---|---|---|---|---|---|---|
| | | | Arcol | | Soybean | Acclaim | Multranol | Acclaim |
| Standard | Monoolein | Diolein | LHT 240 | Triolein | Oil | 2200 | 3400 | 8200 |
| Molecular | 356 | 620 | 707 | 878 | 950 | 2000 | 3000 | 8000 |
| Weight | | | | | | | | |
| (Daltons) | | | | | | | | |

The term “antistrip” or “antistripping” refers to an additive that improves the adhesion between the asphalt binder and mineral aggregates. The use of antistripping additives results in a more durable bond between the asphalt binder and the mineral aggregate when in the presence of moisture, making the combination more resistant to “stripping” or loss of asphalt coating on the mineral aggregate.

The term “iodine value” (commonly abbreviated as IV) as used herein is the mass of iodine in grams that is consumed by 100 grams of a chemical substance. Iodine numbers are often used to determine the amount of unsaturation in fats, oils, and waxes. In fatty acids, unsaturation occurs mainly as double bonds which are very reactive towards halogens, iodine in this case. Thus, the higher the iodine value, the more unsaturation is present in the sample. The Iodine Value of a material can be determined by the standard well-known Wijs method (AOCS (1993) Cd 1-25).

Warm Mix Asphalt (WMA) additives are used to reduce the production and compaction temperatures for asphalt pavements. These additives often help improve the ability of the asphalt binder to coat the mineral aggregates in an asphalt mix and allow for easier compaction of the mix under a roller with lower mechanical or thermal energy requirement. Often it is desirable for such additives to also improve the adhesion between the asphalt and the aggregate and the ability of the coating to resist stripping off in the presence of moisture. The impact of a WMA additive can be demonstrated through its ability to modify the rate of compaction and density achievement of the asphalt mix. These additives are often blended into the bitumen as part of the asphalt binder.

Various theories have been proposed to describe the mechanisms of action of various WMA additives, including plasticizing the binder and reduction of the internal friction between aggregates, although the exact nature of the mechanism is difficult to conclusively determine. Therefore, the discussion of WMA properties is done without being bound to a specific mechanism theory.

The backbone of the durability and quality of asphalt concrete is the adhesion present at the interface between the bitumen and mineral aggregate. Adhesion between the bitumen and mineral aggregates can be weakened over time by many factors including repeated traffic loading, weather, and moisture damage which can manifest itself in various forms including fatigue cracking and distortions such as rutting of the pavement mixes. Moisture susceptibility of the pavement is one of the leading contributing factors of distress in asphalt concrete pavements. Moisture can instigate stripping by permeating into the pores of the mineral aggregates and displacing bitumen film from the mineral aggregate surface. Stripping due to loss of adhesion can eventually lead to premature failure of the pavement.

Asphalt additives that include the combination of epoxidized renewable oil or fat and a phospholipid material have been shown to exhibit improved adhesion promotion. The asphalt additive blends having the combination of epoxidized renewable oils and fats and phospholipid materials have a tendency to form oleogels, increasing viscosity of the asphalt additive. Such oleogels may also lead to storage stability issues unless the blend has been prepared under sufficiently high shear mixing conditions. However, high shear mixing requirements can cause significant operational and manufacturing challenges. In addition, the inclusion of a lower viscosity minor component (such as vegetable oils) as diluents or compatibilizers resulted in storage stability issues due to separation of the minor component.

Surprisingly, the present inventors discovered that the use of high viscosity vegetable oil (i.e., polymerized via sulfurization) as a minor phase addition to the epoxidized renewable oil or fat and phospholipid material combination exhibited an unexpectedly improved stabilization of the blend—allowing for improved manufacturing of stable blends at low shear (e.g., mixing at or below 1500 rpm). The present invention includes the sulfurized renewable oil stabilizer without impacting the performance of the asphalt additive in asphalt applications.

### Asphalt Additive

In one aspect, the present technology provides an asphalt additive that includes a phospholipid material, an epoxidized renewable oil or fat, where the epoxidized renewable oil or fat has an oxirane content of about 1.0% to about 15.0%, and a sulfurized renewable oil stabilizer that includes a polymeric distribution having 2 wt % to about 80 wt % oligomer content; and a sulfur content ranging from about 0.001 wt % to about 8 wt % based on total weight of the sulfurized renewable oil stabilizer. The sulfurized renewable oil stabilizer may further have a PD of about 1.0 to 5.0. For example, the sulfurized renewable oil stabilizer may include a polymeric distribution having 2 wt % to about 80 wt % oligomer content; a PDI ranging from about 1.0 to about 5.0; and a sulfur content ranging from about 0.001 wt % to about 8 wt % based on total weight of the sulfurized renewable oil stabilizer.

The asphalt additive may have a weight ratio of the phospholipid material to the epoxidized renewable of oil or fat of about 5:1 to about 1:5. For example, the weight ratio may be about 5:1 to about 1:5, about 3:1 to about 1:3, about 2:1 to about 1:2, or about 1:1 Suitable weight ratios may include about 5:1, about 4.5:1, about 4:1, about 3.5:1, about 3:1, about 2.5:1, about 2:1, about 1.5:1, about 1:1, about 1:1.5, about 1:2, about 1:2.5, about 1:3, about 1:3.5, about 1:4, about 1:4.5, about 1:5, or any range including and/or in between any two of the preceding values.

The asphalt additive of the present technology may include the phospholipid material in an amount of about 10.0 wt % to about 80.0 wt %. For example, the phospholipid material may be present in an amount about 10.0 wt % to about 80.0 wt %, about 10.0 wt % to about 60 wt. %, about 40.0 wt % to about 60.0 wt %, or about 45.0 wt % to about 55 wt %. The phospholipid material may be present in amounts of about 10.0 wt %, about 15.0 wt %, about 20.0 wt %, about 25.0 wt %, about 30 wt. %, about 35 wt %, about 40.0 wt %, about 45.0 wt %, about 50.0 wt %, about 55.0 wt %, about 60.0 wt %, about 65.0 wt %, about 70.0 wt %, about 75.0 wt %, about 80.0 wt %, or any range including and/or in between any two of the preceding values.

The term “phospholipid material” as used herein refers to a material containing phospholipids. Phospholipids are generally characterized as lipids having a glycerol or sphingosine backbone esterified to two fatty acids and phosphoric acid or a phosphoric acid ester. The phospholipids of the phospholipid material may further include phospholipid derivatives. For example, suitable phospholipid derivatives may include hydrolyzed phospholipids, acetylated phospholipids, epoxidized phospholipids, hydroxylated phospholipids, or mixtures thereof. Typically, the phospholipid material as described herein may include at least about 50 wt % to 100 wt % of phospholipids based on the total weight of the phospholipid material. For example, the phospholipid material may include at least about 50 wt % to 100 wt %, at least about 60 wt % to 100 wt %, at least about 70 wt % to 100 wt %, at least about 80 wt % to 100 wt %, at least about 90 wt % to 100 wt %.

The phospholipids may be natural phospholipids, synthetic phospholipids, or combinations thereof. As described herein, natural phospholipids may be phospholipids from plant, animal, or microbial sources. For example, phospholipids may include, but are not limited to, phosphatidyl choline, phosphatidyl inositol, phosphatidyl ethanolamine, phosphatidic acid, or combinations thereof.

The phospholipid material may include a lecithin material as the phospholipid source. The term “lecithin” or “lecithin material” as used herein refers to a complex mixture of acetone-insoluble phospholipids alone or together with a variety of other compounds, including but not limited to fatty acids, triglycerides, sterols, carbohydrates, glycolipids, and water. Lecithin may be obtained from a variety of sources, including but not limited to plant sources (such as vegetable oils), animal sources (such as egg and bovine brain), or microbial sources. For example, suitable sources of lecithin may include, but are not limited to, soybean lecithin, rapeseed lecithin, sunflower-seed lecithin, egg lecithin, peanut lecithin, corn lecithin, bovine brain lecithin, jojoba lecithin, or mixtures thereof. With respect to the aforementioned lecithin sources, the phospholipid material may be obtained from crude refining streams containing fatty acids and phosphatidyl material, as described in U.S. Pat. No. 10,689,406, incorporated herein by reference in its entirety. Additionally or alternatively, the lecithin may be a modified lecithin. For example, the modified lecithin may include, but is not limited to, hydrogenated lecithin, epoxidized lecithin, de-oiled lecithin, or mixtures thereof.

The lecithin material may include about 5 wt % to 100 wt % of acetone-insoluble matter based on total weight of the lecithin material. Suitable amounts of acetone-insoluble material may include about 5 wt % to 100 wt %, about 5 wt % to about 75 wt %, about 30 wt % to about 70 wt %, or about 40 wt % to about 65 wt %. For example, the lecithin material may include acetone-insoluble matter amounts of about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt % about 90 wt %, about 95 wt %, 100 wt %, or any range including and/or in between any two of the preceding values. Phospholipid content in lecithin compositions is measured using acetone-insoluble testing methods as known to persons of ordinary skill in the art (such as AOCS (2017) Method Ja 4-46).

The asphalt additive may include about 10.0 wt % to about 80.0 wt % of the epoxidized renewable oil or fat based on total weight of the asphalt additive. For example, the epoxidized renewable oil or fat may be present in an amount about 10.0 wt % to about 80.0 wt. %, about 10.0 wt % to about 60.0 wt %, about 40.0 wt % to about 60.0 wt %, or about 45.0 wt % to about 55 wt %. Typically, the asphalt additive may include the epoxidized renewable oil or fat in amounts of about 10.0 wt %, about 15.0 wt %, about 20.0 wt %, about 25.0 wt %, about 30 wt. %, about 35 wt % about 40.0 wt %, about 45.0 wt %, about 50.0 wt %, about 55.0 wt %, about 60.0 wt %, about 65.0 wt %, about 70.0 wt %, about 75.0 wt %, about 80.0 wt %, or any range including and/or in between any two of the preceding values.

The epoxidized renewable oil or fat may have an oxirane content of about 1.0% to about 15.0%, about 4.0% to about 12.0%, about 6.0% to about 10.0%, about 8.0% to about 10.0%, or any range including and/or in between any two of the preceding values. Suitable oxirane contents of the epoxidized renewable oil or fat may include about 1.0%, about 2.0%, about 3.0%, about 4.0%, about 5.0%, about 6.0%, about 7.0%, about 8.0%, about 9.0%, about 10.0%, about 11.0%, about 12.0%, about 13.0%, about 14.0%, about 15.0%, or any range including and/or in between any two of the preceding values. Oxirane content may be determined via AOCS Cd 9-57.

The epoxidized renewable oil or fat includes epoxidized fatty acids or epoxidized fatty acid derivatives. For example, the epoxidized fatty acids or epoxidized fatty acid derivatives may include, but are not limited to, epoxidized vegetable oils, epoxidized acetylated-acylglycerides, epoxidized fatty acid esters, estolides, or combinations thereof.

The epoxidized renewable oil or fat may include epoxidized soybean oil, epoxidized canola oil, epoxidized linseed oil, epoxidized soy methyl ester, epoxidized linseed methyl ester, epoxidized tall oil fatty acid (TOFA), epoxidized acetylated-triacylglycerol, epoxidized acetylated-diacylglycerol, epoxidized acetylated-monoacylglycerol, epoxidized 2-ethylhexyl soyate, epoxidized 2-ethylhexyl TOFA, epoxidized isoamyl soyate, epoxidized isoamyl palm stearin, epoxidized isoamyl TOFA, epoxidized isoamyl soyate, epoxidized soy methyl ester acetic acid estolide, epoxidized jojoba oil, or mixtures thereof. Typically, the epoxidized renewable oil or fat may include epoxidized soy oil, epoxidized linseed oil, epoxidized canola oil, or mixtures thereof. For example, the epoxidized renewable oil or fat may be epoxidized soy oil. In another example, the epoxidized renewable oil or fat may be epoxidized linseed oil.

The epoxidized renewable oil or fat may undergo fractionation or be a fractionated epoxidized renewable oil or fat. As used herein, the term “fractionation” refers to the process of separating a renewable oil or fat into several fractions having different properties including hardness and melting point.

The asphalt additive may include any amount of the sulfurized renewable oil stabilizer, provided that the sulfurized renewable oil stabilizer makes up a minor component of the asphalt additive with respect the phospholipid material and the epoxidized renewable oil or fat. In any aspect, the asphalt additive may include up to about 35 wt % of the sulfurized renewable oil stabilizer based on total weight of the asphalt additive. For example, suitable amounts of the sulfurized renewable oil stabilizer in the asphalt additive may include about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt % about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, or any range including and/or in between any two of the preceding values. In any aspect, the asphalt additive may include about 5 wt % to about 35 wt % of the sulfurized renewable oil stabilizer. In any aspect, the asphalt additive may include about 10 wt % to about 25 wt % of the sulfurized renewable oil stabilizer. In any aspect, the asphalt additive may include about 12 wt % to about 24 wt % of the sulfurized renewable oil stabilizer. In any aspect, the asphalt additive may include about 16 wt % to about 22 wt % of the sulfurized renewable oil stabilizer.

The sulfurized renewable oil stabilizer is a polymerized renewable oil as described herein in any aspect. The polymerized renewable oil may be a polymerization product of a reaction mixture that includes a starting renewable oil or fat and a sulfur-containing compound where the polymerization is sulfurization. Suitable starting renewable oils or fats may include a renewable oil or fat as described heretofore, including but not limited to palm oil, sunflower oil, corn oil, soybean oil, canola oil, rapeseed oil, linseed oil, tung oil, castor oil, tall oil, cottonseed oil, peanut oil, safflower oil, corn stillage oil (recovered corn oil, typically residual liquids resulting from the manufacturing process of turning corn into ethanol), other low cost waste oils (e.g., waste cooking oil or other used oils), or combinations thereof. Suitable sulfur-containing compound may include sulfur in a reduced form. For example, the sulfur-containing compound may include, but is not limited to, elemental sulfur.

The sulfurized renewable oil stabilizer may have a polymeric distribution of about 2 wt % to about 80 wt % oligomer content (about 20 wt % to about 98 wt % monomers), about 15 wt % to about 60 wt % oligomer content (about 40 wt % to about 85 wt % monomers), about 20 wt % to about 60 wt % oligomer content (about 40 wt % to about 80 wt % monomers, about 55 wt % to about 75 wt % oligomer content (about 25 wt % to about 45 wt % monomers), about 50 wt % to about 75 wt % oligomer content (about 25 wt % to about 50 wt % monomers), or any range including and/or in between any two of the preceding values.

The sulfurized renewable oil stabilizer may have a PDI of about 1.0 to about 5.0, about 1.30 to about 2.20, about 1.50 to about 2.05, or any range including and/or in between any two of the preceding values.

The sulfurized renewable oil stabilizer may have a sulfur content of less than about 8 wt %. For example, the sulfur content of the sulfurized renewable oil stabilizer may be about 0.001 wt %, about 0.005 wt %, about 0.01 wt %, about 0.05 wt %, about 0.1 wt %, about 0.5 wt %, about 1 wt %, about 2 wt %, about 3 wt %, about 4 wt %, about 5 wt %, about 6 wt %, about 7 wt %, about 8 wt %, or any range including and/or in between any two of the preceding values.

The sulfurized renewable oil stabilizer may have a flash point, as measured via Cleveland Open Cup method, of about 100 °C to about 400 °C, about 200 °C to about 350 °C, about 220 °C to about 300 °C, about 245 °C to about 275 °C, or any range including and/or in between any two of the preceding values. The viscosity of the sulfurized renewable oil stabilizer may be from about 1 cSt to about 100 cSt at 100 °C.

The asphalt additive may have a weight ratio of the phospholipid material, the epoxidized renewable oil or fat, and the sulfurized renewable oil stabilizer may be about 1:1:1 to about 45:45:1. In any aspect, the weight ratio may be about 1:1:1 to about 20:20:2. In any aspect, the weight ratio may be from about 1:1:1 to about 10:10:2. In any aspect, the weight ration may be about 10:10:2 to about 2:2:1. In any aspect, the weight ratio may be about 2:2:1 to about 1:1:1. In any aspect, the weight ratio may be 20:20:2 to 2:2:1. The weight ratio of the phospholipid material and epoxidized renewable oil or fat may be in a weight ratio as described herein (e.g., about 5:1 to 1:5) where the sulfurized renewable oil stabilizer is a minor component (by weight) of relative to the phospholipid material and the epoxidized renewable oil or fat.

The asphalt additive as described herein may further include a fatty acid material, such as soybean oil, linseed oil, canola oil, or mixtures thereof. Typically, the asphalt additive may include about 0.1 wt % to about 40.0 wt % of the fatty acid material based on total weight of the asphalt additive. Suitable amounts of the fatty acid material may include about 0.1 wt %, about 1.0 wt %, about 5.0 wt %, about 10.0 wt %, about 15.0 wt %, about 20.0 wt %, about 25.0 wt %, about 30.0 wt %, about 35.0 wt %, about 40.0 wt %, or any range including and/or in between any two of the preceding claims. For example, the fatty acid material may be a fractionated fatty acid material.

The asphalt additive as described herein typically has a viscosity of about 20 cSt to about 10,000 cSt at 25 °C; for example, when the asphalt additive is pre-blended prior to use in asphalt applications. Suitable viscosities at 25 °C may include about 20 cSt, about 30 cSt, about 40 cSt, about 50 cSt, about 60 cSt, about 70 cSt, about 80 cSt, about 90 cSt, about 100 cSt, about 200 cSt, about 300 cSt, about 400 cSt, about 500 cSt, about 600 cSt, about 700 cSt, about 800 cSt, about 900 cSt, about 1,000 cSt, about 1,500 cSt, about 2,000 cSt, about 2,500 cSt, about 3,000 cSt, about 3.500 cSt, about 4,000 cSt, about 4,500 cSt, about 5,000 cSt, about 5,500 cSt, about 6,000 cSt, about 6,500 cSt, about 7,000 cSt, about 7,500 cSt, about 8,000 cSt, about 8,000 cSt, about 8,500 cSt, about 9,000 cSt, about 9,500 cSt, about 10,000 cSt, or any range including and/or in between any two of the preceding values.

The inventors discovered the asphalt additive according to the present technology unexpectedly improved one or more performance properties when incorporated into asphalt applications. For example, the asphalt additive as described herein exhibits surprising enhancement of the overall performance of an asphalt or asphalt concrete, including adhesion promotion, antistripping, warm mix asphalt additive, hot mix asphalt additive, compaction aid, and durability of asphalt mixes.

The asphalt additive as described herein typically exhibits enhanced adhesion promotion in asphalt applications.

The asphalt additive as described herein typically exhibits enhanced antistripping in asphalt applications.

The asphalt additive as described herein typically improve compaction in asphalt applications.

The asphalt additive as described herein typically improves durability of asphalt mixes in asphalt applications.

The asphalt additive as described herein typically is a warm mix asphalt additive.

Alternatively, the asphalt additive as described herein may be a hot mix asphalt additive.

The asphalt additive of the present technology surprisingly exhibits improved stability. For example, the asphalt additive exhibits improved stability compared to an asphalt additive without one or more of the phospholipid material, the epoxidized renewable fat or oil, or the sulfurized renewable oil stabilizer.

In an aspect, the present technology provides use of the asphalt additive as described herein to reduce or prevent stripping in asphalt applications.

In another aspect, the present technology provides use of the asphalt additive as described herein as a compaction aid in asphalt applications.

In another aspect, the present technology provides use of the asphalt additive as described herein as an adhesion promoter in asphalt applications.

In yet another related aspect, the present technology provides use of the asphalt additive as described herein as a warm mix asphalt additive or a hot mix asphalt additive in asphalt applications. For example, the use of the asphalt additive is as a warm mix asphalt additive. In another example, the use of the asphalt additive is as a hot mix asphalt additive.

### Asphalt Binder

In another aspect, the present technology provides an asphalt binder that includes bitumen; and an asphalt additive as described herein in any aspect. For purposes of the present technology, the term “bitumen” or “asphalt” refers to the binder phase of asphalt concrete and is a class of black or dark-colored solid, semisolid, resinous or viscous cementitious substances-natural, recycled, or manufactured-composed principally of high molecular weight polar hydrocarbon species (e.g., asphaltenes), of which asphalts, tars, pitches, and asphaltites are typical. (Asphalt, Kirk-Othmer Encyclopedia of Chemical Technology, John Wiley & Sons Inc.)

The asphalt binder may include about 0.1 wt % to about 3.0 wt % of the asphalt additive as described herein based on total weight of the asphalt binder. For example, the asphalt additive may be present in the asphalt binder in amounts of about 0.1 wt % to about 3.0 wt %, about 0.1 wt % to about 2.0 wt %, about 0.1 wt % to about 1.5 wt %, about 0.3 wt % to about 1.0 wt %, or about 0.3 wt % to about 0.7 wt %. Suitable amounts of the asphalt additive may include about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.5 wt %, about 2.0 wt %, about 2.5 wt %, about 3.0 wt %, or any range including and/or in between any two of the preceding values.

The asphalt binder may include about 97.0 wt % to about 99.9 wt % of bitumen based on total weight of the asphalt binder. Suitable amounts of bitumen present in the asphalt binder may include about 97.0 wt %, about 97.5 wt %, about 98.0 wt %, about 98.5 wt %, about 99.0 wt %, about 99.1 wt %, about 99.2 wt %, about 99.3 wt %, about 99.4 wt %, about 99.5 wt %, about 99.6 wt %, about 99.7 wt %, about 99.8 wt %, about 99.9 wt %, or any range including and/or in between any two of the preceding values.

The asphalt binder as described herein may further include one or more additional additives suitable for asphalt applications. For example, the one or more additional additives may include, but are not limited to thermoplastic elastomeric and thermoplastic plastomeric polymers (such as styrene-butadiene-styrene, ethylene vinyl-acetate, functionalized polyolefins, or the like), polyphosphoric acid (PPA), antistripping additives (such as amine-based, phosphate-based, and the like), warm mix additives, emulsifiers, fibers, or mixtures thereof.

The asphalt binder as described herein may further include PPA. Typically, the asphalt binder may include about 0.1 wt % to about 5.0 wt % of PPA based on total weight of the asphalt binder. For example, the asphalt binder may include PPA in an amount of about 0.1 wt %, about 0.5 wt %, about 1.0 wt %, about 1.5 wt %, about 2.0 wt %, about 2.5 wt %, about 3.0 wt %, about 3.5 wt %, about 4.0 wt %, about 4.5 wt %, about 5.0 wt %, or any range including and/or in between any two of the preceding values.

### Asphalt Concrete

In yet another aspect, the present technology provides an asphalt concrete that includes about 0.25 wt % to about 8.0 wt % of an asphalt binder as described herein in any aspect (based on total weight of the asphalt concrete) and about 92.00 wt % to about 99.75 wt % of mineral aggregate (based on total weight of the asphalt concrete). As described herein, the asphalt binder includes bitumen and the asphalt additive.

The asphalt concrete as described herein may include about 0.25 wt % to about 8.0 wt %, about 0.25 wt % to about 6.5 wt %, about 0.25 wt % to about 5.0 wt %, about 0.30 wt % to about 4.0 wt %, or about 0.5 wt % to about 3.5 wt % of the asphalt binder based on total weight of the asphalt. For example, the asphalt binder may be present in the asphalt concrete in amounts of about 0.25 wt %, about 0.30 wt %, about 0.40 wt %, about 0.50 wt %, about 0.60 wt %, about 0.70 wt %, about 0.80 wt %, about 0.90 wt %, about 1.0 wt %, about 1.5 wt %, about 2.0 wt %, about 2.5 wt %, about 3.0 wt %, about 3.5 wt %, about 4.0 wt %, about 4.5 wt %, about 5.0 wt %, about 5.5 wt %, about 6.0 wt %, about 6.5 wt %, about 7.0 wt %, about 7.5 wt %, about 8.0 wt %, or any range including and/or in between any two of the preceding values.

“Mineral aggregates” refers to the solid and generally inert load supporting components, including but not limited to clay, sand, gravel, crushed stone, slag, or rock dust, of asphalt concrete. The mineral aggregate may be further characterized by its calcium carbonate content. For purpose of the present technology, the calcium carbonate concentration of the mineral aggregates can be determined to classify the chemistry of the aggregates. The main component of limestone is calcium carbonate, which may be determined by back titration that includes adding an excess amount of acid to the unknown basic aggregates and then titrated back to the endpoint with a standardized NaOH. Typically, the mineral aggregates used in asphalt applications may be the result of one or more sources of aggregate as described herein (e.g., stone, rock, gravel, and the like), each of which may be further crushed, screened or graded to meet various mineral aggregate gradations. Mineral aggregate gradations used in asphalt applications are generally classified with terms such as “dense graded,” “gap graded,” “well graded,” and “poorly graded,” depending on the application. Mineral aggregate gradations in asphalt applications are typically defined by the largest sieve opening size that retains a portion of the gradation. For example, the largest size may include, but is not limited to, 1.5″, 1″, ¾″, and ½″ sieve sizes.

The asphalt concrete may include the mineral aggregates in amounts of about 92.00 wt % about 92.50 w-t %, about 93.00 wt %, about 93.50 wt %, about 94.00 wt %, about 94.50 wt %, about 95.00 wt %, about 95.50 wt %, about 96.00 wt %, about 96.50 wt %, about 97.00 wt %, about 97.50 wt %, about 98.0 wt %, about 98.5 wt %, about 99.0 wt %, about 99.25 wt %, about 99.50 wt %, about 99.75 wt %, or any range including and/or in between any two of the preceding values.

The asphalt concrete may further include recycled materials. For example, the recycled material may include recycled bituminous material, recycled aggregates, reclaimed asphalt pavement (RAP) millings, recycled asphalt shingles (RAS), or mixtures thereof.

### Methods

In another aspect, the present technology provides a process for preparing a stable asphalt additive blend. The method of preparing the stable asphalt additive blend includes: mixing a phospholipid material, an epoxidized renewable oil or fat having an oxirane content of about 1.0% to about 15.0%, and a sulfurized renewable oil stabilizer to obtain the asphalt additive blend; wherein the sulfurized renewable oil stabilizer includes a polymeric distribution of about 2 wt % to about 80 wt % oligomer content; and a sulfur content ranging from about 0.001 wt % to about 8 wt % based on total weight of the sulfurized renewable oil stabilizer. The sulfurized renewable oil stabilizer may further include a PDI of about 1.0 to about 5.0. For example, the sulfurized renewable oil stabilizer may include a polymeric distribution of about 2 wt % to about 80 wt % oligomer content; a PDI ranging from about 1.0 to about 5.0; and a sulfur content ranging from about 0.001 wt % to about 8 wt % based on total weight of the sulfurized renewable oil stabilizer.

The method may further include heating the epoxidized renewable oil or fat, sulfurized renewable oil stabilizer, and phospholipid material prior to mixing, combining the epoxidized renewable oil or fat and sulfurized renewable oil stabilizer to obtain a first blend, mixing the first blend, combining the first blend with the phospholipid material, and mixing the first blend with the phospholipid material.

The inventors surprisingly discovered that the method of the present invention is a scalable method for producing a homogenous and storage-stable asphalt additive blend from epoxidized renewable oils or fats with phospholipid materials in the presence of the sulfurized renewable oil stabilizer to produce when prepared under low shear. Low shear mixing may be carried out according to any suitable method known in the art, including methods suitable for plant (or large scale) manufacturing. For example, mixing may be carried out with any suitable manufacturing equipment sufficient to obtain a homogenous mixture under low shear to produce present asphalt additive system.

In one example, the low shear mixing may include, but is not limited to, blending the phospholipid material, epoxidized renewable oil or fat, and sulfurized renewable oil stabilizer at shear rates including about 500 rpm to about 1500 rpm, about 600 rpm to about 1500 rpm, about 750 rpm to about 1500 rpm, about 1000 rpm to about 1500 rpm, or any range including and/or in between any two of the preceding values. Alternatively, the mixing may include blending at high shear rates, such as shear rates greater than 1500 rpm and up to about 3500 rpm. Suitable high shear rates may include, but are not limited to about 1600 rpm to about 3500 rpm, about 2000 rpm to about 3500 rpm, about 2500 rpm to about 3000 rpm, about 3000 rpm to about 3500 rpm, or any range including and/or in between any two of the preceding values.

The resultant asphalt additive blend is in keeping with the asphalt additive as described herein in any aspect.

The method may be a performed for batch or continuous preparation of the asphalt additive blend.

In an aspect, the present technology provides a method for preparing an asphalt binder that includes mixing a phospholipid material, an epoxidized renewable oil or fat having an oxirane content of about 1.0% to about 15.0%, and a sulfurized renewable oil stabilizer to obtain the asphalt additive blend; wherein the sulfurized renewable oil stabilizer that includes a polymeric distribution having about 2 wt % to about 80 wt % oligomer content; and a sulfur content ranging from about 0.001 wt % to about 8 wt % based on total weight of the sulfurized renewable oil stabilizer. The sulfurized renewable oil stabilizer may further include a PDI of about 1.0 to about 5.0. For example, the sulfurized renewable oil stabilizer may include a polymeric distribution of about 2 wt % to about 80 wt % oligomer content; a PDI ranging from about 1.0 to about 5.0; and a sulfur content ranging from about 0.001 wt % to about 8 wt % based on total weight of the sulfurized renewable oil stabilizer.

In another aspect, the present technology provides a method for reducing or preventing stripping, promoting adhesion, aiding compaction, and/or improving durability of an asphalt concrete that includes:
adding an asphalt additive as described herein to bitumen to obtain an asphalt binder, and
combining the asphalt binder to mineral aggregates to obtain an asphalt concrete;
wherein the asphalt concrete includes about 0.25 wt % to about 8.0 wt % of the asphalt binder and about 92.00 wt % to about 99.75 wt % of the mineral aggregates.

The present invention, thus generally described, will be understood more readily by reference to the following examples, which are provided by way of illustration and are not intended to be limiting of the present invention.

### EXAMPLES

### General Methods and Materials

Sulfurized refined soybean oil (Sf. SBO) was prepared as described in PCT Application Serial No. PCT/US2016/019767. In particular, when prepared in the laboratory a charge of precipitated sulfur is added to a 1 liter round bottom flask containing 650 grams of vegetable oil. The reactor is then heated to the target reaction temperature using a heating mantle, taking care not to overshoot the target temperature by more than 5 °C. The reaction mixture is agitated using a motorized stirrer with a stir shaft and blade. The reaction is continuously sparged with nitrogen at 2-12 standard cubic feet per hour (SCFH). A condenser and receiving flask is used to collect any distillate.

It is noted that the reaction will create foam around 110-115 °C when the sulfur melts into the oil. The reaction is monitored using GPC, to measure the oligomer content and distribution, and viscosity is measured at 40 °C using ASTM D445. The reaction is considered complete when the desired oligomer content has been achieved. The reactor is then cooled 60 °C.

In the following examples the Sf. SBO sample was prepared by reacting refined soybean oil with 7.0 wt % of elemental sulfur at 175-185 °C for about 33 h under a nitrogen sparge, resulting in a polymerized oil (via sulfurization) having about 70.0 wt % oligomer content and a sulfur content of 7.0 wt %. Although it is possible to dilute the sulfurized oil with additional vegetable oil or derivatives (i.e., non-sulfurized oil), it was found that undiluted sulfurized oil was preferred due to improved storage stability in the blend described in these examples.

### Blending Process

For lab batch production, an overhead drill mixer was used for low shear blending at either 600 or 1500 rpm. High shear mixing was performed using an IKA Ultra Turrax T50 model with a R1402 dissolver and a rotor/stator G45-G at shear rates of 3000-3500 rpm.

All components were heated to 50 °C to achieve a lower viscosity but not high enough to exceed the phospholipid decomposition temperature. For blends that include Sf. SBO, the Sf. SBO was first blended with epoxidized linseed oil (ELO) at the target concentration. The soy lecithin (SL) was slowly added to the Sf SBO/ELO mixture at low shear or high shear rates.

### Stability Test Method

### Centrifuge:

To assess long term storage stability of different mixtures Samples were subjected to centrifugation at 2300 rpm for a total of 40 minutes. The test method mimics static storage over the course 8-10 weeks for assessing phase separation of the asphalt additives.

Visual assessment was performed at different time intervals of 10 min, 20 min, and 40 min. Phase behavior of the blends was evaluated at room temperature at each time interval. Results were recorded as % volume of “supernatant” and “precipitant” based on the graduation on the vials.

“Supernatant” is defined as the translucent layer when the vial was held up to light, and the “precipitant” is defined as the sludgy layer at the bottom that separates and sticks to the bottom the vial immediately upon flipping the vial upside down.

A lower value of the supernatant and precipitant would indicate higher stability and is more desirable.

In this study, the key element of phase behavior assessment was determined to be the degree of precipitation and supernatant (clear top layer). Both precipitates and supernatants were selected to be the qualitative measurement of storage stability. Precipitation and supernatants were measured in milliliters and converted to vol % by total volume of the mixture.

### Example 1—Impact of Shearing Speed and Type on Asphalt Additive Blend Stability

Following the blending process described herein, low shear blends were prepared at 600 and 1500 rpm, while high shear blends were prepared at 3250 rpm. The relative ratio of SL to ELO remained 1:1, while the minor component made up 20 wt % of the final blend. The overall blend ratio of SL/ELO/Sf SBO was 2:2:1 by weight. Blend ratios and stability test results are shown in Table 1.

TABLE 1
Impact of shearing rate and type on stability test results.

| Blend Ratio and | Minor Fraction | | | Supernatant at | Supernatant at | Supernatant at | Precipitate at |
|---|---|---|---|---|---|---|---|
| Components | (% wt.) | Shear Type | RPM | 10 mins, % Vol | 20 mins, % Vol | 40 mins, % Vol | 40 mins, % vol |
| 1:1 SL/ELO | 0.0% | Low shear | 600 | 4.2% | 8.3% | 12.5% | 50.00% |
| 1:1 SL/ELO | 0.0% | Low shear | 1500 | 4.2% | 8.3% | 12.5% | 50.00% |
| 1:1 SL/ELO | 0.0% | High Shear | 3250 | 4.2% | 8.3% | 12.5% | 41.67% |
| 2:2:1 SL/ELO/Sf. SBO | 20.0% | Low shear | 600 | 0.0% | 0.0% | 0.0% | 15.67% |
| 2:2:1 SL/ELO/Sf. SBO | 20.0% | Low shear | 1500 | 0.0% | 0.0% | 0.0% | 16.17% |
| 2:2:1 SL/ELO/Sf. SBO | 20.0% | High shear | 3250 | 0.0% | 0.0% | 0.0% | 0.67% |

As shown in Table 1, the blends containing Sf SBO as a minor component stabilizer showed a significant improvement over blends having SL/ELO only. Accordingly, the SL/ELO/Sf. SBO blends exhibited improved blend stability in terms of supernatant and precipitant separation compared to the two-component SL/ELO blends.

### Example 2—Impact of Addition of Different Minor Components During the Blending Process of ELO and SL

Following the blending procedure previously described, blends were made under low shear at 600 rpm. In each blend, the relative ratio of SL to ELO remained 1:1, while the minor component made up 20% of the final blend. The overall blend ratio of SL/ELO/Minor Component can be described as 2:2:1 by weight. The minor components compared were selected from Sf. SBO, a refined bleached and deodorized soybean (SBO), and a fuel grade soy methyl ester (SME). Blend ratios and stability test results are shown in Table 2.

TABLE 2
Blend ratios and stability test results with varying minor component blends.

| Blend Ratio and | Minor Fraction | | | Supernatant at | Supernatant at | Supernatant at | Precipitate at |
|---|---|---|---|---|---|---|---|
| Components | (% wt.) | Shear Type | RPM | 10 mins, % Vol | 20 mins, % Vol | 40 mins, % Vol | 40 mins, % vol |
| 1:1 SL/ELO | 0.0% | Low shear | 600 | 4.2% | 8.3% | 12.5% | 50.00% |
| 2:2:1 SL/ELO/SME | 20.0% | Low shear | 600 | 41.7% | 50.0% | 50.0% | 58.33% |
| 2:2:1 SL/ELO/SBO | 20.0% | Low shear | 600 | 41.7% | 50.0% | 50.0% | 58.33% |
| 2:2:1 SL/ELO/Sf. SBO | 20.0% | Low shear | 600 | 0.0% | 0.0% | 0.0% | 15.67% |

As shown in Table 2, the blend containing Sf SBO as the minor component stabilizer showed a significantly improved stability in terms of supernatant and precipitant compared to the SL/ELO blend as well as three-component blends having SME and SBO, respectively, as the minor component. In particular, blends containing SBO and SME as low viscosity diluents exhibited in significantly reduced stability compared to the SL/ELO blend and SL/ELO/Sf. SBO blend.

### Example 3A—Impact of Sf. SBO Concentration on the Stability of the Asphalt Additive

Following the blending procedure previously described, the blends were prepared under low shear at 600 rpm. The relative ratio of SL to ELO remained 1:1, while the minor component was progressively varied between 5% up to 33.3% of the final blend. Blend ratios and stability test results are shown in Table 3.

TABLE 3
Impact of Sf. SBO concentration at low shear on stability test results.

| Blend Ratio and | Minor Fraction | | | Supernatant at | Supernatant at | Supernatant at | Precipitate at |
|---|---|---|---|---|---|---|---|
| Components | (% wt.) | Shear Type | RPM | 10 mins, % Vol | 20 mins, % Vol | 40 mins, % Vol | 40 mins, % vol |
| 1:1 SL/ELO | 0.0% | Low shear | 600 | 4.2% | 8.3% | 12.5% | 50.00% |
| 19:19:2 SL/ELO/Sf. SBO | 5.0% | Low shear | 600 | 0.0% | 4.2% | 8.3% | 16.00% |
| 9:9:2 SL/ELO/Sf. SBO | 10.0% | Low shear | 600 | 0.0% | 2.1% | 6.7% | 15.83% |
| 2:2:1 SL/ELO/Sf. SBO | 20.0% | Low shear | 600 | 0.0% | 0.0% | 0.0% | 15.67% |
| 1:1:1 SL/ELO/Sf. SBO | 33.3% | Low shear | 600 | 0.0% | 0.0% | 0.0% | 16.17% |

As shown in Table 3, increasing the Sf. SBO concentration continuously improved the stability in terms of the supernatant up to 20% concentration. Additional loading of the Sf. SBO (33 wt %) showed improved stability over the two-component SL/ELO blend only. In terms of the precipitate, the maximum benefit was achieved after 5% inclusion and further increase did not result in additional improvement. Overall, the results showed that an inclusion of Sf SBO under low shear improved stability compared to the SL/ELO blend.

### Example 3B—Impact of Sf. SBO on the Stability of the 1:1 SL/ELO Blend

Following the blending procedure previously described, blends were made under high shear at 2000 rpm. The relative ratio of SL to ELO remained 1:1 for the two blends as shown in Table 4, while the minor component was added to the second blend during the mixing process to 20% of the final blend. Blend ratios and stability test results are shown in Table 4.

TABLE 4
Impact of inclusion of Sf. SBO at high shear on stability
test results with a fixed blend ratios of 1:1 SL/ELO.

| | | | | Precipitate | Precipitate |
|---|---|---|---|---|---|
| Blend | Minor | | | at | at |
| Ratio and | Fraction | | | 15 mins, | 30 mins, |
| Components | (% wt.) | Shear Type | RPM | % vol | % vol |
| 1:1 SL/ELO | 0.0% | High Shear | 2000 | 25.0% | 33.3% |
| 2:2:1 SL/ELO/Sf. | 20.0% | High Shear | 2000 | 15.8% | 17.7% |
| SBO | | | | | |

### Example 3C—Impact of Sf. SBO on the Stability of the 2:7 SL/ELO Blend

Following the blending procedure previously described, blends were made under high shear at 2000 rpm. The relative ratio of SL to ELO remained 2:7, while the minor component made up 10% of the final blend. A 2:7 SL/ELO blend with a higher proportion of ELO, which exhibited a significantly lower stability over that of the 1:1 SL/ELO, saw a significant improvement with the addition of 10% Sf. SBO of the final blend during the mixing process. Blend ratios and stability test results are shown in Table 5.

TABLE 5
Impact of inclusion of Sf. SBO at high shear on stability
test results with a fixed blend ratios of 2:7 SL/ELO.

| | | | | Precipitate | Precipitate |
|---|---|---|---|---|---|
| Blend | Minor | | | at | at |
| Ratio and | Fraction | | | 15 mins, | 30 mins, |
| Components | (% wt.) | Shear Type | RPM | % vol | % vol |
| 2:7 SL/ELO | 0.0% | High Shear | 2000 | 75.0% | 75.0% |
| 2:7:1 SL/ELO/Sf. | 10.0% | High Shear | 2000 | 9.0% | 8.3% |
| SBO | | | | | |

As shown in Tables 4 and 5, incorporation of Sf. SBO under high shear at 2000 RPM significantly improved stability compared to the two-component SL/ELO blend indicated by the level of precipitate after 15 mins and 30 mins of centrifuge at 2300 RPM. Adding the minor component, 20% by weight of the final blend to the SL/ELO blend at relative ratio of 1:1 saw a 9.2% and 15.6% improvement in terms of precipitate at 15 mins and 30 mins of centrifuge respectively compared to that of the two-component blend system.

Addition of the minor component in the 2:7 SL/ELO saw a surprisingly significant improvement over the SL/ELO blend by 66% and 66.7% in terms of precipitate at 15 mins and 30 mins of centrifuge respectively.

Overall, the results showed that an inclusion of Sf SBO under high shear improved stability compared to the SL/ELO blend. 2:7:1 SL/ELO/Sf. SBO blend surprisingly demonstrated a significantly improved stability compared to the two-components SL/ELO blend.

### Example 4—Evaluation of Synergistic Antistripping Properties Exhibited by Addition of Sf. SBO to the SL/ELO Asphalt Additive in Asphalt Applications

Antistripping was evaluated using the Shaker Table Stripping Test. This test was used to evaluate the affinity between the aggregates and bitumen after conditioning the bitumen-covered aggregates in water at 60 °C with orbital agitation of variable speed for a period of time. The test method was adapted based on the Quebec DOT method (“The Evaluation of Binder Resistance to Stripping for a Given Aggregate Surface.” Quebec Department of Transportation, 2002). Suitable orbital agitation speeds may be from 1 to 300 rpm, for example, from 100 to 200 rpm. Suitable test times can be from 1 to 48 h, for example, from 6 to 24 h. The agitation of the mix simulates potential moisture damage in pavement mixtures and accounts for displacement mechanism and stripping potential of the bitumen covered aggregates by water. The percentage of the bitumen coating retained on the aggregates is then visually evaluated by quantifying the bitumen covered rocks by which 90% coated is deemed pass as opposed to the uncoated rocks. In this example an agitation speed of 200 rpm, a test temperature of 60 °C, and a test time of 25 h were used for 75 gram asphalt mix samples, prepared as described.

In the present example mineral aggregates used were graded to all be at a size of 4.75 mm to 9.5 mm. The aggregates were washed on a sieve under running tap water to remove any debris and dusts that may interfere with coverage surface area of the aggregates, and subsequently dried in a force draft oven at 100 °C. These processes were followed to reduce the variability in the test results which were noted on the Quebec DOT method. This procedure is an improvement of the incumbent Quebec DOT stripping test. The asphalt binder prepared included 99.5 wt % of bitumen and 0.5 wt % of the warm mix additive blends (asphalt additive blends). The blend with asphalt binder was prepared by heating the binder to 150 °C in a force draft oven, adding room temperature additive at proper weight, and blending using a metal spatula for 30 s. 3.2 wt % of the asphalt binder by weight of the aggregates were further combined and blended with the mineral aggregates for 2 min. The dosage level of the additive may depend on the mineralogy of the aggregates such as surface chemistry and gradation of the aggregates. The asphalt binder-aggregate mix was then placed in the 150 °C force draft oven to ensure uniform coating of the aggregates. The sequence was repeated 4 to 5 times until the mix was uniformly dispersed. The finished blend was subsequently transferred, spread evenly onto the even surface, and allowed to cure for 24 h. Approximately 75 g of the material and 100 g of water were transferred into a 120 mL bottle and was placed in the orbital shaker table to assess the stripping potential of the asphalt mix.

The asphalt binder used in this example was a standard paving grade binder designated as a PG 64-22. The aggregate used contains 53.97% of CaCO3. Table 4 shows the measured results from two replicate tests, along with the associated average. For the case of the blends, the “predicted” performance was calculated as the weighted linear average of the performance of each individual component in the asphalt mix. If no synergistic interaction was to occur as a result of the blending of components it would be expected that the measured results be statistically similar to the predicted results.

As shown in Table 6, the 1:1 SL/ELO additive exhibited a greater antistripping performance than the linear average of the individual performance of SL and ELO as additives. The 2:2:1 SL/ELO/Sf. SBO blend surprisingly exhibited a comparable antistripping performance (i.e., no statistically significant loss) compared to the 1:1 SL/ELO blend, for either low shear or high shear blended versions. This is an unexpected but significant result as it indicates that the addition of the Sf SBO not only allowed for the preparation of a stable SL and ELO blend at low shear, but did so without diluting the performance or product efficiency.

TABLE 6
Improvement of coating to the control mix (no additive).

| | | | | Prediction |
|---|---|---|---|---|
| | | | | for |
| Additive in | % coating | | | Blends by |
| Asphalt Binder | retained post | | Average % | Weighted |
| (Dosed at | shaker table 25 h | | Retained | Linear |
| 0.5% by weight) | (Each Replicate) | | Coating | Average |
| No additive | 30.84% | 37.46% | 34.15% | N/A |
| Sf. SBO | 43.55% | 50.88% | 47.22% | N/A |
| SL | 59.03% | 66.62% | 62.83% | N/A |
| ELO | 88.29% | 90.26% | 89.28% | N/A |
| 1:1 SL/ELO -High Shear | 88.25% | 90.70% | 89.48% | 76.05% |
| 2:2:1 SL/ELO/Sf. | 89.45% | 92.03% | 90.74% | 70.28% |
| SBO -Low Shear | | | | |
| 2:2:1 SL/ELO/Sf. | 82.05% | 90.48% | 86.27% | 70.28% |
| SBO -High Shear | | | | |

### Example 5—Evaluation of Synergistic Antistripping Properties Exhibited by Addition of Sf. SBO to the SL/ELO Asphalt Additive in Asphalt Applications

Antistripping was evaluated using the Shaker Table Stripping Test as previously described. As shown in Table 7, both the 1:1 SL/ELO and 2:7:1 SL/ELO/Sf. SBO additive exhibited a greater antistripping performance than the linear average of the individual performance of SL, ELO, and/or Sf SBO as additives. This is an unexpected but significant result as it indicates that the addition of the Sf SBO not only allowed for the preparation of a stable SL and ELO blend at higher proportion of ELO at high shear but did so without diluting the performance or product efficiency.

Overall, Sf. SBO was added without impacting the performance efficiency of the asphalt additive in asphalt applications.

TABLE 7
Improvement of coating to the control mix (no additive).

| | | | | Prediction |
|---|---|---|---|---|
| | | | | for |
| Additive in | % coating | | | Blends by |
| Asphalt Binder | retained post | | Average % | Weighted |
| (Dosed at | shaker table 24 h | | Retained | Linear |
| 0.5% by weight) | (Each Replicate) | | Coating | Average |
| No additive | 2.16% | 6.66% | 4.41% | N/A |
| Sf. SBO | 12.60% | 16.02% | 14.31% | N/A |
| SL | 25.63% | 38.16% | 31.90% | N/A |
| ELO | 51.70% | 63.08% | 57.39% | N/A |
| 1:1 SL/ELO -High Shear | 47.22% | 57.79% | 52.51% | 44.64% |
| 2:7:1 SL/ELO/Sf. | 48.35% | 58.74% | 53.55% | 47.98% |
| SBO -High Shear | | | | |
| Phosphate Ester | 48.82% | 55.61% | 52.22% | N/A |

As shown in Examples 3A-C, 4, and 5, incorporating Sf SBO not only exhibited performance efficiency of the additive in asphalt application, but also significantly improved the stability over that of the two-component blend.

### EXEMPLARY ASPECTS

The following exemplary aspects of the present invention is as set out in the following clauses, the numbering of which is not to be construed as designating levels of importance:

1. An asphalt additive comprising:
a phospholipid material;
an epoxidized renewable oil or fat, wherein the epoxidized renewable oil or fat has an oxirane content of about 1.0% to about 15.0%; and
a sulfurized renewable oil stabilizer comprising:
a polymeric distribution having about 2 weight percent (wt %) to about 80 wt % oligomer content; and
a sulfur content ranging from about 0.001 wt % to about 8 wt %; and
wherein the sulfurized renewable oil stabilizer is a polymerized oil obtained via sulfurization.

2. The asphalt additive of clause 1, wherein the asphalt additive comprises a weight ratio of the phospholipid material to the epoxidized renewable oil or fat of about 5:1 to about 1:5.

3. The asphalt additive of clause 1 or 2, wherein the asphalt additive comprises a weight ratio of the phospholipid material to the epoxidized renewable oil or fat of about 3:1 to about 1:3.

4. The asphalt additive of any one of clauses 1-3, wherein the asphalt additive comprises a weight ratio of the phospholipid material to the epoxidized renewable oil or fat of about 2:1 to about 1:2.

5. The asphalt additive of any one of clauses 1-4, wherein the asphalt additive comprises a weight ratio of the phospholipid material to the epoxidized renewable oil or fat of about 1:1.

6. The asphalt additive of any one of clauses 1-5, wherein the asphalt additive comprises about 10.0 wt % to about 80.0 wt % of the phospholipid material based on total weight of the asphalt additive.

7. The asphalt additive of any one of clauses 1-6, wherein the asphalt additive comprises about 10.0 wt % to about 60.0 wt % of the phospholipid material based on total weight of the asphalt additive.

8. The asphalt additive of any one of clauses 1-7, wherein the phospholipid material comprises at least about 50 wt % to 100 wt % of phospholipids based on total weight of the phospholipid material.

9. The asphalt additive of any one of clauses 1-8, wherein the phospholipid material comprises at least about 80 wt % to 100 wt % of phospholipids based on total weight of the phospholipid material.

10. The asphalt additive of any one of clauses 1-9, wherein the phospholipids comprise natural phospholipids, synthetic phospholipids, or combinations thereof.

11. The asphalt additive of clause 10, wherein the natural phospholipids comprise phospholipids from plant, animal, or microbial sources.

12. The asphalt additive of any one of clauses 1-11, wherein the phospholipid material comprises phosphatidyl choline, phosphatidyl ethanolamine, phosphatidyl inositol, phosphatidic acid, or combinations thereof.

13. The asphalt additive of any one of clauses 1-12, wherein the phospholipid material comprises a lecithin material.

14. The asphalt additive of clause 13, wherein the lecithin material comprises about 5 wt % to about 100 wt % of acetone-insoluble matter.

15. The asphalt additive of any one of clauses 1-14, wherein the lecithin material comprises soybean lecithin, rapeseed lecithin, sunflower-seed lecithin, egg lecithin, peanut lecithin, corn lecithin, bovine brain lecithin, jojoba lecithin, or mixtures thereof.

16. The asphalt additive of any one of clauses 1-15, wherein the additive comprises about 10.0 wt % to about 80.0 wt % of the epoxidized renewable oil or fat based on total weight of the asphalt additive.

17. The asphalt additive of any one of clauses 1-16, wherein the epoxidized renewable oil or fat has an oxirane content of about 4.0% to about 12.0%.

18. The asphalt additive of any one of clauses 1-17, wherein the epoxidized renewable oil or fat has an oxirane content of about 6.0% to about 10.0%.

19. The asphalt additive of any one of clauses 1-18, wherein the epoxidized renewable oil or fat has an oxirane content of about 8.0% to about 10.0%.

20. The asphalt additive of any one of clauses 1-19, wherein the epoxidized renewable oil or fat comprises an epoxidized fatty acid or fatty acid derivative.

21. The asphalt additive of clause 20, wherein the epoxidized fatty acid or fatty acid derivative comprises epoxidized vegetable oils, epoxidized acetylated-acylglycerides, epoxidized glycidyl ethers, epoxidized fatty acid esters, estolides, or mixtures thereof.

22. The asphalt additive of any one of clauses 1-21, wherein the epoxidized renewable oil or fat comprises epoxidized soybean oil, epoxidized canola oil, epoxidized linseed oil, epoxidized soy methyl ester, epoxidized linseed methyl ester, epoxidized tall oil fatty acid (TOFA), epoxidized acetylated-triacylglycerol, epoxidized acetylated-diacylglycerol, epoxidized acetylated-monoacylglycerol, epoxidized jojoba oil, epoxidized 2-ethylhexyl soyate, epoxidized 2-ethylhexyl TOFA, epoxidized isoamyl soyate, epoxidized isoamyl palm stearin, epoxidized isoamyl TOFA, epoxidized isoamyl soyate, epoxidized soy methyl ester acetic acid estolide, or mixtures thereof.

23. The asphalt additive of any one of clauses 1-22, wherein the epoxidized renewable oil or fat comprises epoxidized linseed oil, epoxidized soybean oil, or mixtures thereof.

24. The asphalt additive of any one of clauses 1-22, wherein the epoxidized renewable oil or fat comprises epoxidized linseed oil.

25. The asphalt additive of any one of clauses 1-22, wherein the epoxidized renewable oil or fat comprises epoxidized soybean oil.

26. The asphalt additive of any one of clauses 1-25, wherein the epoxidized renewable oil or fat has undergone fractionation.

27. The asphalt additive of any one of clauses 1-26, wherein the asphalt additive comprises up to about 35 wt % of the sulfurized renewable oil stabilizer based on total weight of the asphalt additive.

28. The asphalt additive of any one of clauses 1-27, wherein the asphalt additive comprises about 1 wt % to about 35 wt % of the sulfurized renewable oil stabilizer based on total weight of the asphalt additive.

29. The asphalt additive of any one of clauses 1-28, wherein the asphalt additive comprises about 16 wt % to about 22 wt % of the sulfurized renewable oil stabilizer based on total weight of the asphalt additive.

30. The asphalt additive of any one of clauses 1-29, wherein the sulfurized renewable oil stabilizer has a polymeric distribution of about 55 wt % to about 75 wt % oligomer content.

31. The asphalt additive of any one of clauses 1-30, wherein the sulfurized renewable oil stabilizer has a sulfur content of about 2 wt % to about 6 wt %.

32. The asphalt additive of any one of clauses 1-31, wherein the sulfurized renewable oil stabilizer further has a PDI of about 1.0 to about 5.0, preferably about 1.30 to about 2.20.

33. The asphalt additive of any one of clauses 1-32, wherein the sulfurized renewable oil stabilizer has a flash point ranging from about 100 °C to about 400 °C.

34. The asphalt additive of any one of clauses 1-33, wherein the sulfurized renewable oil stabilizer is the polymerization product of a reaction mixture comprising a sulfur-containing compound and a starting renewable oil or fat, and wherein the polymerization is sulfurization.

35. The asphalt additive of clause 34, wherein the starting renewable oil or fat is selected from the group consisting of palm oil, sunflower oil, corn oil, soybean oil, canola oil, rapeseed oil, linseed oil, tung oil, castor oil, tall oil, cottonseed oil, peanut oil, safflower oil, corn stillage oil, and combinations thereof.

36. The asphalt additive of clause 34 or clause 35, wherein the sulfur-containing compound comprises elemental sulfur.

37. The asphalt additive of any one of clauses 1-35, wherein the asphalt additive comprises a weight ratio of the phospholipid material, the epoxidized renewable oil or fat, and the sulfurized renewable oil stabilizer is from 45:45:1 to 1:1:1.

38. The asphalt additive of any one of clauses 1-36, wherein the asphalt additive comprises a weight ratio of the phospholipid material, the epoxidized renewable oil or fat, and the sulfurized renewable oil stabilizer is from 10:10:2 to 2:2:1.

39. The asphalt additive of any one of clauses 1-38 further comprising a fatty acid material, wherein the fatty acid material comprises soybean oil, linseed oil, canola oil, or mixtures thereof.

40. The asphalt additive of clause 27, wherein the additive comprises about 0.1 wt % to about 40 wt % of the fatty acid material based on total weight of the additive.

41. The asphalt additive of clause 39 or 40, wherein the fatty acid material has undergone fractionation.

42. The asphalt additive of any one of clauses 39-41, wherein the additive comprises about 1 wt % to about 35 wt % of the fatty acid material based on total weight of the additive.

43. The asphalt additive of any one of clauses 1-42, wherein the asphalt additive is a warm mix asphalt additive.

4. The asphalt additive of any one of clauses 1-43, wherein the asphalt additive is a hot mix asphalt additive.

45. The asphalt additive of any one of clauses 1-44, wherein the asphalt additive enhances one or more performance properties in asphalt applications comprising adhesion, compaction, durability, antistripping, or combinations thereof.

46. The asphalt additive of any one of clauses 1-45, wherein the asphalt additive exhibits improved stability compared to an asphalt additive without one or more of the phospholipid material, the epoxidized renewable fat or oil, or the sulfurized renewable oil stabilizer.

47. Use of the asphalt additive of any one of clauses 1-46 to reduce or prevent stripping in asphalt applications.

48. Use of the asphalt additive of any one of clauses 1-46 as a compaction aid in asphalt applications.

49. Use of the asphalt additive of any one of clauses 1-46 to promote adhesion in asphalt applications.

50. Use of the asphalt additive of any one of clauses 1-46 as a warm mix asphalt additive or hot mix asphalt additive in asphalt applications.

51. An asphalt binder comprising:
bitumen; and
an asphalt additive according to any one of clauses 1-46.

52. The asphalt binder of clause 51, wherein the asphalt binder comprises about 0.1 wt % to about 3.0 wt % of the asphalt additive based on total weight of the asphalt binder.

53. The asphalt binder of clause 51 or clause 52, wherein the asphalt binder comprises about 0.3 wt % to about 0.7 wt % of the asphalt additive based on total weight of the asphalt binder.

54. The asphalt binder of any one of clauses 51-53, wherein the asphalt binder comprises about 97.0 wt % to about 99.9 wt % of bitumen based on total weight of the asphalt binder.

55. The asphalt binder of any one of clauses 51-54 further comprising one or more additional additives.

56. The asphalt binder of any one of clauses 51-55 further comprising polyphosphoric acid.

57. An asphalt concrete comprising:
about 0.25 wt % to about 8.0 wt % of an asphalt binder, based on total weight of the asphalt concrete, comprising:
bitumen; and
an asphalt additive according to any one of clauses 1-46; and
mineral aggregate.

58. The asphalt concrete of clause 57, wherein the asphalt concrete comprises about 92.0 wt % to about 99.75 wt % of the mineral aggregate based on total weight of the asphalt concrete.

59. A method of preparing a stable asphalt additive blend, the method comprising:
mixing a phospholipid material, an epoxidized renewable oil or fat having an oxirane content of about 1.0% to about 15.0%, and a sulfurized renewable oil stabilizer to obtain the asphalt additive blend;
wherein the sulfurized renewable oil stabilizer comprises:
a polymeric distribution having about 2 weight percent (wt %) to about 80 wt % oligomer content:
optionally, a polydispersity index (PDI) ranging from about 1.0 to about 5.0; and
a sulfur content ranging from about 0.001 wt % to about 8 wt %;
wherein the sulfurized renewable oil stabilizer is a polymerized oil obtained via sulfurization.

60. The method of clause 59, wherein the asphalt additive comprises a weight ratio of the phospholipid material, the epoxidized renewable oil or fat, and the sulfurized renewable oil stabilizer is from 45:45:1 to 1:1:1.

61. The method of clause 59 or 60, wherein the asphalt additive blend comprises a weight ratio of the phospholipid material, the epoxidized renewable oil or fat, and the sulfurized renewable oil stabilizer is from 10:10:2 to 2:2:1.

62. The method of any one of clauses 59-61, wherein the mixing comprises blending at a shear rate of about 600 rpm to about 1500 rpm.

63. The method of any one of clauses 59-61, wherein the mixing comprises blending at a shear rate of greater than 1500 rpm.

64. The method of any one of clauses 59-61, wherein the mixing comprises blending at a shear rate of greater than 1500 rpm to about 3500 rpm.

65. The method of clause 64, wherein the mixing comprises blending at a shear rate of about 3000 rpm to about 3500 rpm.

66. The method of any one of clauses 59-65, wherein the asphalt additive blend exhibits improved stability compared to an asphalt additive without one or more of the phospholipid material, the epoxidized renewable fat or oil, or the sulfurized renewable oil stabilizer.

67. The asphalt additive of any one of clauses 59-66, wherein the asphalt additive blend enhances one or more performance properties in asphalt applications comprising adhesion, compaction, durability, antistripping, or combinations thereof.

68. The method of any one of clauses 59-67, wherein the asphalt additive blend is a warm mix asphalt additive.

69. The method of any one of clauses 59-67, wherein the asphalt additive blend is a hot mix asphalt additive.

70. A method of preparing an asphalt binder comprising:
combining bitumen with the asphalt additive according to any one of clauses 1-46.

71. The method of clause 70 further comprising combining one or more additional additives to the bitumen and asphalt additive.

72. A method for reducing or preventing stripping, promoting adhesion, aiding compaction, and/or improving durability of asphalt concrete comprising:
combining the asphalt additive according to any one of clauses 1-46 to bitumen to obtain an asphalt binder, and
combining the asphalt binder to mineral aggregates to obtain an asphalt concrete;
wherein the asphalt binder comprises about 0.25 wt % to about 8.0 wt % of the asphalt concrete.

Accordingly, the examples provided herein show the asphalt additive of the present technology exhibits improved storage stability compared to an asphalt additive not containing the combination of phospholipid material, epoxidized renewable oil or fat, and sulfurized renewable oil stabilizer. In addition, the asphalt additives of the present technology exhibit an synergistic antistripping properties.

Each of the non-limiting aspects above can stand on its own or can be combined in various permutations or combinations with one or more of the other aspects or other subject matter described in this document. While the invention has been illustrated and described in certain aspects, a person with ordinary skill in the art, after reading the foregoing specification can effect changes, substitutions of equivalents and other types of alterations to the present technology as set forth herein. Each aspect described above can also have included or incorporated therewith such variations or aspects as disclosed in regard to any or all of the other aspects.

The present technology is also not to be limited in terms of the particular aspects described herein, which are intended as single illustrations. Many modifications and variations of this present technology can be made without departing from its spirit and scope, as will be apparent to those skilled in the art from the foregoing descriptions. Such modifications and variations are intended to fall within the scope of the appended claims. It is to be understood that this present technology is not limited to particular methods, reagents, compounds, or compositions, which can, of course, vary. It is also to be understood that the terminology used herein is for the purpose of describing particular aspects only and is not intended to be limiting. Thus, it is intended that the specification be considered as exemplary only with the breadth, scope and spirit of the present technology indicated only by the appended claims, definitions therein and any equivalents thereof.

The aspects, illustratively described herein may suitably be practiced in the absence of any element or elements, limitation or limitations, not specifically disclosed herein. Thus, for example, the terms “comprising,” “including,” “containing,” etc. shall be read expansively and without limitations. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter form the genus, regardless of whether or not the excised material is specifically.

1. An asphalt additive comprising:
a phospholipid material;
an epoxidized renewable oil or fat, wherein the epoxidized renewable oil or fat has an oxirane content of about 1.0% to about 15.0%; and
a sulfurized renewable oil stabilizer comprising:
a polymeric distribution having about 2 weight percent (wt %) to about 80 wt % oligomer content; and
a sulfur content ranging from about 0.001 wt % to about 8 wt %; and
wherein the sulfurized renewable oil stabilizer is a polymerized oil obtained via sulfurization.

2. The asphalt additive of claim 1, wherein the asphalt additive comprises a weight ratio of the phospholipid material to the epoxidized renewable oil or fat of about 5:1 to about 1:5.

3. The asphalt additive of claim 1, wherein the asphalt additive comprises about 10.0 wt % to about 80.0 wt % of the phospholipid material based on total weight of the asphalt additive.

4. The asphalt additive of claim 1, wherein the phospholipid material comprises a lecithin material.

5. The asphalt additive of claim 1, wherein the lecithin material is selected from the group consisting of soybean lecithin, rapeseed lecithin, sunflower-seed lecithin, egg lecithin, peanut lecithin, corn lecithin, bovine brain lecithin, jojoba lecithin, and mixtures thereof.

6. The asphalt additive of claim 1, wherein the additive comprises about 10.0 wt % to about 80.0 wt % of the epoxidized renewable oil or fat based on total weight of the asphalt additive.

7. The asphalt additive of claim 1, wherein the epoxidized renewable oil or fat has an oxirane content of about 4.0% to about 12.0%.

8. The asphalt additive of claim 1, wherein the epoxidized renewable oil or fat is selected from the group consisting of epoxidized soybean oil, epoxidized canola oil, epoxidized linseed oil, epoxidized soy methyl ester, epoxidized linseed methyl ester, epoxidized tall oil fatty acid (TOFA), epoxidized acetylated-triacylglycerol, epoxidized acetylated-diacylglycerol, epoxidized acetylated-monoacylglycerol, epoxidized jojoba oil, epoxidized 2-ethylhexyl soyate, epoxidized 2-ethylhexyl TOFA, epoxidized isoamyl soyate, epoxidized isoamyl palm stearin, epoxidized isoamyl TOFA, epoxidized isoamyl soyate, epoxidized soy methyl ester acetic acid estolide, and mixtures thereof.

9. The asphalt additive of claim 1, wherein the asphalt additive comprises up to about 35 wt % of the sulfurized renewable oil stabilizer based on total weight of the asphalt additive.

10. The asphalt additive of claim 1, wherein the sulfurized renewable oil stabilizer further has a PDI of about 1.0 to about 5.0.

11. The asphalt additive of claim 1, wherein the asphalt additive comprises a weight ratio of the phospholipid material, the epoxidized renewable oil or fat, and the sulfurized renewable oil stabilizer is from 45:45:1 to 1:1:1.

12. The asphalt additive of claim 1, wherein the asphalt additive is a warm mix asphalt additive or a hot mix additive.

13. The asphalt additive of claim 1, wherein the asphalt additive enhances one or more performance properties in asphalt applications selected from the group consisting of adhesion, compaction, durability, antistripping, and combinations thereof.

14. The asphalt additive of claim 1, wherein the asphalt additive exhibits improved stability compared to an asphalt additive without one or more of the phospholipid material, the epoxidized renewable fat or oil, or the sulfurized renewable oil stabilizer.

15. (canceled)

16. An asphalt binder comprising:
bitumen; and
an asphalt additive according to claim 1 in an amount of about 0.1 wt % to about 3.0 wt % based on total weight of the asphalt binder.

17. The asphalt binder of claim 16, wherein the asphalt binder comprises about 97.0 wt % to about 99.9 wt % of bitumen based on total weight of the asphalt binder.

18. An asphalt concrete comprising:
about 0.25 wt % to about 8.0 wt % of an asphalt binder, based on total weight of the asphalt concrete, comprising:
bitumen; and
an asphalt additive according to claim 1; and
about 92.0 wt % to about 99.75 wt % of mineral aggregate based on total weight of the asphalt concrete.

19. A method of preparing a stable asphalt additive blend, the method comprising:
mixing a phospholipid material, an epoxidized renewable oil or fat having an oxirane content of about 1.0% to about 15.0%, and a sulfurized renewable oil stabilizer to obtain the asphalt additive blend;
wherein the sulfurized renewable oil stabilizer comprises:
a polymeric distribution having about 2 weight percent (wt %) to about 80 wt % oligomer content;
optionally, a polydispersity index (PDI) ranging from about 1.0 to about 5.0; and
a sulfur content ranging from about 0.001 wt % to about 8 wt %;
wherein the sulfurized renewable oil stabilizer is a polymerized oil obtained via sulfurization.

20. The method of claim 19, wherein the mixing comprises blending at a shear rate of about 600 rpm to about 1500 rpm; or a shear rate of greater than 1500 rpm.

21. (canceled)

22. A method for reducing or preventing stripping, promoting adhesion, aiding compaction, and/or improving durability of asphalt concrete comprising:
combining the asphalt additive according to claim 1 to bitumen to obtain an asphalt binder, and
combining the asphalt binder to mineral aggregates to obtain an asphalt concrete;
wherein the asphalt binder comprises about 0.25 wt % to about 8.0 wt % of the asphalt concrete.
